(19) United States
(12) Patent Application Publication
(10) Pub. No.: US 2009/0035704 A1
(43) Pub. Date: Feb. 5, 2009

(54) Underlayer Coating Composition Based on a Crosslinkable Polymer

(76) Inventors: Hong Zhuang, Raritan, NJ (US); Huirong Yao, Plainsboro, NJ (US); Hengpeng Wu, Hillsborough, NJ (US); Mark Neisser, Whitehouse Station, NJ (US); Weihong Liu, Bridgewater, NJ (US); Jianhui Shan, Pennington, NJ (US); Zhong Xiang, Edison, NJ (US)

Correspondence Address: SANGYA JAIN;AZ ELECTRONIC MATERIALS USA CORP., 70 MEISTER AVENUE, SOMERVILLE, NJ, 08876, US

(21) Appl. No.: 11/833,361

(22) Filed: Aug. 3, 2007

(51) Int. Cl. G03C 1/00; G03C 5/00

(52) U.S. Cl. 430/311; 430/270.1

(57) ABSTRACT

The present invention relates to an underlayer coating composition capable of being crosslinked comprising a polymer, a compound capable of generating a strong acid, and optionally a crosslinker, where the polymer comprises at least one absorbing chromophore and at least one moiety selected from an epoxy group, an aliphatic hydroxy group and mixtures thereof.

The invention further relates to a process of imaging the underlayer coating compositions.

### FIELD OF INVENTION

The present invention relates to an underlayer coating composition comprising a crosslinkable polymer, and a process for forming an image using the antireflective coating composition. The process is especially useful for imaging photoresists using radiation in the deep and extreme ultraviolet (uv) region.

### BACKGROUND OF INVENTION

Photoresist compositions are used in microlithography processes for making miniaturized electronic components such as in the fabrication of computer chips and integrated circuits. Generally, in these processes, a thin coating of film of a photoresist composition is first applied to a substrate material, such as silicon based wafers used for making integrated circuits. The coated substrate is then baked to evaporate any solvent in the photoresist composition and to fix the coating onto the substrate. The baked coated surface of the substrate is next subjected to an image-wise exposure to radiation.

This radiation exposure causes a chemical transformation in the exposed areas of the coated surface. Visible light, ultraviolet (UV) light, electron beam and X-ray radiant energy are radiation types commonly used today in microlithographic processes. After this image-wise exposure, the coated substrate is treated with a developer solution to dissolve and remove either the radiation-exposed or the unexposed areas of the photoresist.

The trend towards the miniaturization of semiconductor devices has led to the use of new photoresists that are sensitive to lower and lower wavelengths of radiation and has also led to the use of sophisticated multilevel systems to overcome difficulties associated with such miniaturization. Absorbing antireflective coatings and underlayers in photolithography are used to diminish problems that result from back reflection of light from highly reflective substrates and for filling vias in the substrate. Two major disadvantages of back reflectivity are thin film interference effects and reflective notching. Thin film interference, or standing waves, result in changes in critical line width dimensions caused by variations in the total light intensity in the photoresist film as the thickness of the photoresist changes or interference of reflected and incident exposure radiation can cause standing wave effects that distort the uniformity of the radiation through the thickness. Reflective notching becomes severe as the photoresist is patterned over reflective substrates containing topographical features, which scatter light through the photoresist film, leading to line width variations, and in the extreme case, forming regions with complete photoresist loss. An antireflective coating coated beneath a photoresist and above a reflective substrate provides significant improvement in lithographic performance of the photoresist. Typically, the bottom antireflective coating is applied on the substrate and then a layer of photoresist is applied on top of the antireflective coating. The antireflective coating is cured to prevent intermixing between the antireflective coating and the photoresist. The photoresist is exposed imagewise and developed. The antireflective coating in the exposed area is then typically dry etched using various etching gases, and the photoresist pattern is thus transferred to the substrate. Multiple layers of antireflective coatings may also be used to optimize lithographic properties. Antireflective coatings may also be used as gap or via filling materials for processes such as dual damascene in multilevel interconnection processes.

The present invention relates to an underlayer coating composition capable of being crosslinked comprising a polymer and a compound capable of generating a strong acid, where the polymer comprises at least one absorbing chromophore and at least one moiety selected from an epoxy group, an aliphatic hydroxy group and mixtures thereof. The antireflective coating or underlayer of the present invention is useful as a gap filling material, especially since the coating has low out-gassing, minimal amount of cure shrinkage, essentially neutral pH, less tendency for footing residues at the photoresist and antireflective coating interface, and good wetting properties to provide good filling properties.

### SUMMARY OF THE INVENTION

The present invention relates to an underlayer coating composition capable of being crosslinked comprising a polymer and a compound capable of generating a strong acid, where the polymer comprises at least one absorbing chromophore and at least one moiety selected from an epoxy group, an aliphatic hydroxy group and mixtures thereof.

The invention also relates to an underlayer coating composition capable of being crosslinked comprising a polymer and a compound capable of generating a strong acid, where the polymer comprises at least one absorbing chromophore, at least one epoxy group and at least one aliphatic hydroxy group.

The invention further relates to a process of imaging a photoresist using the underlayer coating composition.

### BRIEF DESCRIPTION OF THE DRAWINGS

FIG. 1 relates to examples of epoxy containing moieties

FIG. 2 relates to examples of hydroxy containing moieties.

### DESCRIPTION OF THE INVENTION

The present invention relates to a novel underlayer (also known as antireflective or a via filling) coating composition capable of being crosslinked comprising a polymer and a compound capable of generating a strong acid, where the polymer comprises at least one absorbing chromophore and at least one moiety selected from an epoxy group, an aliphatic hydroxy group and mixtures thereof. The composition, especially for via filling materials, may range from highly absorbing to minimally absorbing. The composition may optionally further comprise a crosslinker. The invention also relates to a process of imaging a photoresist using the novel underlayer coating composition.

The novel underlayer coating composition comprises an absorbing polymer which has a chromophore which is absorbing at the wavelength used to expose the photoresist coated above the underlayer coating. The polymer also comprises a functional group which is capable of crosslinking the polymer and the functional group may be selected from an epoxy group, an aliphatic hydroxy group and mixtures thereof. Aliphatic hydroxy group refers to a moiety where the hydroxy (OH) group is adjacent to an aliphatic carbon, i.e. (C—(Y)C(X)—OH, where Y and X are nonaromatic), that is, the hydroxy group is not attached to a carbon of an aromatic ring. The crosslinking in the present composition between an epoxy and a hydroxy group or between multiple epoxy groups is advantageous for many reasons, such as, no volatile compounds are released during the crosslinking and thus eliminating void formation during the curing or post-curing processes. The nature of the crosslinking involves minimal amount of cure shrinkage and can minimize the bias between isolated and dense features, which is essential for via filling of the antireflective coating composition. Epoxy groups, in particular, have good substrate wetting properties and therefore can fill the gaps between the small dimensions Without defects. Neutral or essentially neutral compositions have fewer tendencies to form ‘footing’ or interface residues between the imaged photoresist features and the antireflective coating. Optionally, a crosslinking agent may be present in the novel composition.

The underlayer coating composition may comprise a polymer with at least one absorbing chromophore, at least one epoxy group and the polymer is free of hydroxy groups, a compound capable of generating a strong acid, and optionally a compound with at least two aliphatic hydroxy groups. The compound with the hydroxy groups may be a polymer, an oligomer or a small molecule with a weight average molecular weight of less than 1,000. Optionally, a crosslinking agent may be present in the novel composition.

The underlayer coating composition may comprise a polymer with at least one absorbing chromophore, at least one aliphatic hydroxy group and free of epoxy groups, a compound with at least two epoxy groups, and a compound capable of generating a strong acid. The compound with the epoxy groups may be a polymer, an oligomer or a small molecule with a weight average molecular weight of less than 1,000. Optionally, a crosslinking agent may be present in the novel composition.

The underlayer coating composition may comprise a polymer with at least one absorbing chromophore, at least one epoxy group and at least one aliphatic hydroxy group, and a compound capable of generating a strong acid. Optionally, a crosslinking agent may be present in the novel composition.

In any one or all of the novel embodiments, the polymer of the composition can be free of silicon groups.

The chromophore group in the polymer of the present invention may be selected from an absorbing group which absorbs the radiation used to expose the photoresist, and such chromophore groups can be exemplified by aromatic functionalities or heteroaromatic functionalities. Unsaturated nonaromatic functionalities may also be absorbing. Further examples of the chromophore are without limitation, a substituted or unsubstituted phenyl group, a substituted or unsubstituted anthracyl group, a substituted or unsubstituted phenanthryl group, a substituted or unsubstituted naphthyl group, a sulfone-based compound, benzophenone-based compound, a substituted or an unsubstituted heterocyclic aromatic ring containing heteroatoms selected from oxygen, nitrogen, sulfur; and a mixture thereof. Specifically, the chromophore functionality can be phenyl, benzyl, naphthalene or anthracene based compounds and may have at least one group selected from hydroxy group, carboxyl group, hydroxyalkyl group, alkyl, alkylene, etc. Examples of the chromophore moiety are also given in US 2005/0058929. More specifically the chromophore may be phenyl, benzyl, hydroxyphenyl, 4-methoxyphenyl, 4-acetoxyphenyl, t-butoxyphenyl, t-butylphenyl, alkylphenyl, chloromethylphenyl, bromomethylphenyl, 9-anthracene methylene, 9-anthracene ethylene, and their equivalents. In one embodiment a substituted or unsubstituted phenyl group is used, such as hydroxyphenyl, alkylenephenyl, aniline, phenylmethanol, and benzoic acid. The chromophore may be attached to the polymer by a single bond, an ethylenic group, ester group, ether group, alkylene group, alkyleneester, alkyleneether, or any other linking group. The polymer backbone may be ethylenic, (meth)acrylate, linear or branched alkylene, aromatic, aromatic ester, aromatic ether, alkylene ester, alkylene ether, etc. The chromophore may itself form the backbone of the polymer, such as a monomer derived from aromatic polyol, an aromatic dianhydride; for example pyromellitic dianhydride, resorcinol and 4,4′-oxydiphthalic anhydride. Examples of monomers with a chromophore, which may be polymerized with other comonomers to give the polymer of the present invention, may be monomers comprising substituted or unsubstituted phenyl, such as styrene, hydroxystyrene, benzyl(meth)acrylate, benzylalkylene (meth)acrylate; monomers comprising substituted or unsubstituted naphthyl, monomers comprising substituted or unsubstituted anthracyl, such as anthracene methyl(meth)acrylate, 9-anthracene methyl (meth)acrylate, and 1-naphthyl 2-methylacrylate.

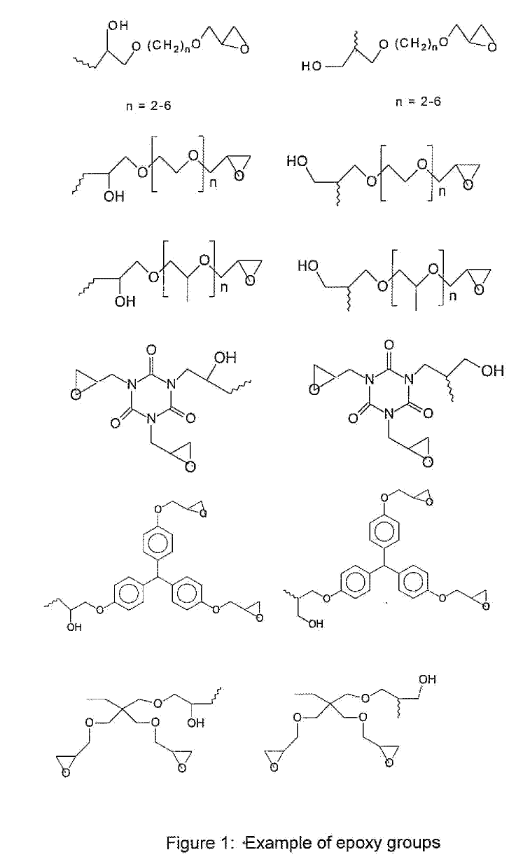

In the embodiments of the present invention, where the polymer comprises an epoxy group, the epoxy group may be connected directly to the backbone of the polymer or through a connecting group. Throughout, the epoxy group refers to a 3-membered ring containing oxygen in the ring. Preferably the epoxy group is a terminal epoxy. Preferably the epoxy ring is not directly attached to an aromatic group, that is, the epoxy ring is directly attached to an aliphatic carbon which may be attached to an aromatic group. The connecting group may be any essentially organic group, such as hydrocarbyl or hydrocarbylene group. Examples are a substituted or unsubstituted (C₁-C₂₀) cycloaliphatic group, a linear or branched (C₁-C₂₀) substituted or unsubstituted aliphatic alkylene group, (C₁-C₂₀) alkyl ether, (C₁-C₂₀) alkyl carboxyl, a heterocyclic group, aryl group, substituted aryl group, aralkyl group, alkylenearyl group or mixtures of these groups. The backbone of the polymer may be any typical polymer, such as an ethylenic, alkylene ether, linear or branched aliphatic alkylene, linear or branched aliphatic alkylene ester, aromatic and/or aliphatic polyester resins. The polyester can be made from the esterification of polyols (more than one hydroxy) with diacids or diahydrides and could be reacted further with a compound to provide the epoxy group and/or hydroxy group. Examples of monomers with an epoxy group which may be formed by free radical polymerization with other comonomers to give the polymer of the present invention comprising an epoxy group, may be glycidyl(meth)acrylate, vinylbenzoyl glycidyl ether, and 1,2-epoxy-4-vinylcyclohexane. Examples of pendant epoxy groups are given in FIG. 1.

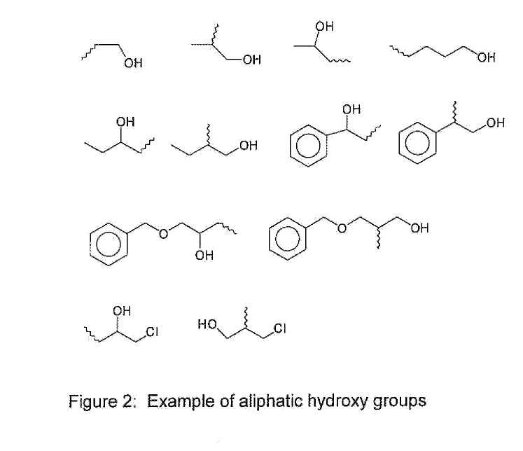

In the embodiments, where the polymer comprises the aliphatic hydroxy group, the aliphatic hydroxy group may be connected directly to the backbone of the polymer or through a connecting group. Preferably the hydroxy group is a primary or secondary alcohol. The connecting group may be any essentially organic group, such as a hydrocarbyl or hydrocarbylene group; examples are a substituted or unsubstituted (C₁-C₂₀) cycloaliphatic group, a linear or branched (C₁-C₂₀) substituted or unsubstituted aliphatic alkylene group, a linear, branched or cyclic (C₁-C₂₀) substituted or unsubstituted halogentated aliphatic alkylene group, (C₁-C₂₀) alkyl ether, (C₁-C₂₀) alkyl carboxyl, (C₁-C₂₀) alkylene ether, (C₁-C₂₀) alkylene carboxyl, a substituted or unsubstituted heterocyclic group, aryl group, substituted or unsubstituted aryl group, aralkyl group, alkylenearyl group or mixtures of these groups. Examples of the pendant hydroxy moieties attached to the polymer are given in FIG. 2. The backbone of the polymer may be any of the known polymers, such as ethylenic, alkylene ether, alkylene ester, alkylene ether, linear or branched aliphatic alkylene, linear or branched aliphatic alkylene ester, and aromatic and/or aliphatic polyester resins. The polyester can be made from the esterification of polyols (more than one hydroxy) with diacids or diahydrides and could be reacted further with a compound to provide the hydroxy group. Examples of monomers with an hydroxy group which may be polymerized with other comonomers to give the polymer of the present invention may be hydroxyethyl(meth)acrylate, hydroxypropyl(meth)acrylate, hydroxyisopropyl (meth)acrylate, polyester, polyester made from the esterification of polyols(diol or triol) with diacids or diahydrides and could be reacted further to provide the aliphatic hydroxy group.

In the embodiment where the polymer comprises a chromophore, at least one epoxy group and at least one aliphatic hydroxy group, any of the epoxy monomeric units and aliphatic hydroxy monomeric units described herein or similar ones may be used. The epoxy group(s) and the aliphatic hydroxy group(s) may be in the same moiety pendant from the polymer; examples of which are given in FIG. 1. Examples of polymers are copolymers of glycidyl methacrylate and 2-hydroxypropylmethacrylate, ter-polymer of glycidyl methacrylate, benzyl methacrylate and 2-hydroxypropylmethacrylate, and polyesters with pendant groups in FIG. 1.

In all the embodiments of the polymer, together with the monomer(s) with functional group(s) described herein, the polymer may incorporate other comonomeric units derived from monomers such as (meth)acrylates, vinyl ethers, vinyl esters, vinyl carbonates, styrene, a styrene, N-vinyl pyrrolidone, etc.

Examples of a polymer comprising epoxy groups that are used to crosslink with a polymer comprising a chromophore and an aliphatic hydroxy group are poly(glycidyl methacrylate-co-styrene), EPON™ Bisphenyl A Epoxy Resins (available from Hexion Specialty Chemicals Inc. Houston, Tex.), and D.E.N. epoxy novolac resins (available from The Dow Chemical Co. Midland, Mich.). Any polymer or compound comprising more than one epoxy group may be used.

Example of polymers comprising hydroxy groups and not epoxy groups can be polyesters, polyvinyl alcohols, hydroxy functionalized poly(meth)acrylates. Polyesters may be made from the esterification of polyols(diol or triol) with diacids or ahydrides, such as esterification of neopentyl glycol or 1,1,1-tris(hydroxymethyl)propane with an aromatic dianhydride; for example pyromellitic dianhydride, 4,4′-oxydiphthalic anhydride or aromatic diacid such as phthalic acid.

Examples of compounds comprising more than one hydroxy functional groups and no epoxy groups are NPG (neopentyl glycol), TMP (1,1,1-tris(hydroxymethyl)propane), pentaerythritol, and dipentaerythritol.

Examples of compounds comprising only epoxy functional groups are 1,4-cyclohexanedimethanol diglycidyl ether, triglycidyl-p-aminophenol, tetraglycidyl ether of tetrakis(4-hydroxyphenyl)ethane.

The term (meth)acrylate refers to methacrylate or acrylate, and similarly, (meth)acrylic refers to methacrylic or acrylic.

Organic group refers to any moiety useful in the realm of organic chemistry, and having an essentially carbon and hydrogen framework. Other heteroatom may also be present.

As used herein, the terms “hydrocarbyl group” and “hydrocarbylene group” are used in its ordinary sense, which is well-known to those skilled in the art, as a moiety having a predominantly hydrocarbon character. “Hydrocarbylene group” can refer to hydrocarbyl group with an additional point of attachment. Examples of hydrocarbyl groups, which can be unsubstituted or substituted, include: (1) hydrocarbon groups, that are, aliphatic (e.g., alkyl, alkylenyl or alkenyl), alicyclic (e.g., cycloalkyl, cycloalkenyl), aromatic, aliphatic-, and alicyclic-substituted aromatic substituents, as well as cyclic substituents wherein the ring is completed through another portion of the molecule (e.g., two substituents together form an alicyclic radical); monocyclic or polycyclic alkylene, arylene, aralkylene. Examples of the monocyclic cycloalkylene group can have from 4 to 20 carbon atoms, and include such as, for example, cyclopentylene and cyclohexylene groups, and the polycyclic cycloalkylene group can have from 5 to 20 carbon atoms and include such as, for example, 7-oxabicyclo[2,2,1]heptylene, norbornylene, adamantylene, diamantylene, and triamantylene.

Examples of the arylene group include monocyclic and polycyclic groups such as, for example, phenylene, naphthylene, biphenyl-4,4′-diyl, biphenyl-3,3′-diyl, and biphenyl-3,4′-diyl groups.

Aryl refers to an unsaturated aromatic carbocyclic group of from 6 to 20 carbon atoms having a single ring or multiple condensed (fused) rings and include, but are not limited to, for example, phenyl, tolyl, dimethylphenyl, 2,4,6-trimethylphenyl, naphthyl, anthryl and 9,10-dimethoxyanthryl groups.

Aralkyl refers to an alkyl group containing an aryl group. It is a hydrocarbon group having both aromatic and aliphatic structures, that is, a hydrocarbon group in which an alkyl hydrogen atom is substituted by an aryl group, for example, tolyl, benzyl, phenethyl and naphthylmethyl groups.

(2) hydrocarbon groups that contain atoms other than carbon and hydrogen but are predominantly hydrocarbon in nature, where examples of other atoms are sulfur, oxygen or nitrogen, which may be present alone (such as thio or ether) or as functional linkages such as ester, carboxy, carbonyl, etc.;

(3) substituted hydrocarbon groups, that is, substituents containing non-hydrocarbon groups which, in the context of this invention, do not alter the predominantly hydrocarbon substituent (e.g., halogen, hydroxy, epoxy, alkoxy, mercapto, alkylmercapto, nitro, nitroso, and sulfoxy);

(4) hetero substituents, that is, substituents which, while having a predominantly hydrocarbon character, in the context of this invention, contain other than carbon in a ring or chain otherwise composed of carbon atoms. Heteroatoms include sulfur, oxygen, nitrogen, and encompass substituents as pyridyl, furyl, thienyl, cyanate, isocyanate, and imidazolyl.

Examples of hydrocarbyl groups are substituted or unsubstituted linear or branched aliphatic (C₁₋₂₀) alkyl groups substituted or unsubstituted linear or branched aliphatic (C₁₋₂₀) alkylene group, substituted or unsubstituted linear or branched thio-alkylene aliphatic (C₁₋₂₀) group, substituted or unsubstituted cycloalkylene, substituted or unsubstituted benzyl, alkoxy alkylene, alkoxyaryl, substituted aryl, hetero cycloalkylene, heteroaryl, oxocyclohexyl, cyclic lactone, benzyl, substituted benzyl, hydroxy alkyl, hydroxyalkoxyl, alkoxy alkyl, alkoxyaryl, alkylaryl, alkenyl, substituted aryl, hetero cycloalkyl, heteroaryl, nitroalkyl, haloalkyl, alkylimide, alkyl amide, or mixtures thereof.

Furthermore, and as used herein, the term “substituted” is contemplated to include all permissible substituents of organic compounds. In a broad aspect, the permissible substituents include acyclic and cyclic, branched and unbranched, carbocyclic and heterocyclic, aromatic and non-aromatic substituents of organic compounds. Illustrative substituents include, for example, those described hereinabove. The permissible substituents can be one or more and the same or different for appropriate organic compounds. For purposes of this invention, the heteroatoms such as nitrogen may have hydrogen substituents and/or any permissible substituents of organic compounds described herein which satisfy the valencies of the heteroatoms. This invention is not intended to be limited in any manner by the permissible substituents of organic compounds.

Hydrocarbyl groups, for example include alkyl, cycloalkyl, substituted cycloalkyl, oxocyclohexyl, cyclic lactone, benzyl, substituted benzyl, hydroxy alkyl, hydroxyalkoxyl, alkoxy alkyl, alkoxyaryl, alkylaryl, alkenyl, substituted aryl, hetero cycloalkyl, heteroaryl, nitro, halogen, haloalkyl, ammonium, alkyl ammonium, —(CH₂)₂OH, —O(CH₂)₂O(CH₂)OH, —(OCH₂CH₂)ₖOH (where k 1-10), and mixtures thereof.

Examples of hydrocarbylene groups are hydrocarbyl groups described herein with another point of attachment to a nonhydrogen moiety.

Examples of polymers made by free radical polymerization of unsaturated monomers, and are exemplified by (meth)acrylates, vinyl polymers, vinyl ether polymers, poly(co-styrene) copolymers. Polymers may be made from unsaturated monomers such as substituted or unsubstituted styrene, glycidyl (meth)acrylate, hydroxypropyl(meth)acrylate, methyl(meth)acrylate, hydroxystyrene, (meth)acrylonitrile, (meth)acrylamide. Additionally, the composition may be free of basic amino compounds, especially those that are crosslinking agents, such as melamine based compounds. The polymer is capable of crosslinking with itself. In this embodiment no external crosslinking compounds are essential, but may be used. Preferably no amino-based crosslinker is used.

In one of the embodiments of the polymer in the underlayer composition, the absorbing polymer may also be polyester comprising at least one chromophore and at least one moiety selected from an epoxy group, an aliphatic hydroxy group or mixture thereof. Thus the composition comprises the polyester and a compound capable of forming a strong acid. The composition may further comprise a crosslinker (crosslinking agent). The polyester polymer may contain at least one chromophore, at least one aliphatic hydroxy group and at least one epoxy group. The functional groups on the polymer, chromophore, epoxy and hydroxy, have been described previously. Typically a polyester resin is made from the reaction of at least one polyol (e.g. 2-5 hydroxy) with at least one diacid or dianhydride, Mixtures of polyols and mixtures of dianhydrides may be used to form the polymer and optionally reacted further to cap any free acid groups. Fully capped polyesters are preferred, such that there is no free carboxylic acid. The acid group in the polymer may be capped with a capping group, and is formed by reacting the polyester comprising the acid group with a suitable capping compound. Capping groups are shown in FIGS. 1 and 2. The capping group may comprise hydroxy and/or epoxy functionalities. The capping compound can typically be aromatic oxide, aliphatic oxide, alkylene carbonate and mixtures thereof. The capping compound can comprise more than one epoxy group and/or more than one aliphatic hydroxy group. The capping compounds can comprise groups shown in FIGS. 1 and 2. Preferably no free acid groups remain in the polymer. The aromatic chromophore functionality, as described previously, may be present in the polyol monomeric unit and/or in the diacid or dianhydride unit, and may form the backbone of the polymer and/or be pendant from the polymer backbone. The aromatic chromophore functionality may be present in the capping group. The general description of polyesters are described in US 2004/0101779, U.S. Pat. No. 7,081,511, and U.S. Ser. No. 10/502,706, and incorporated herein by reference. The polyester may be further exemplified by a polymer comprising a unit of structure 1,

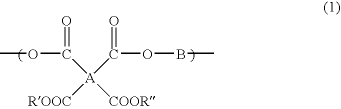

where, A, B, R′ and R″ are independently selected from an organic group, where, at least one selected from R′, R″, A and B comprises at least one selected from an epoxy group, an aliphatic hydroxy group and mixtures thereof, and at least one selected from R′, R″, A and B comprises an aromatic chromophore. In another embodiment of the polymer, the polymer has the structure (1), where, A, B, R′ and R″ are independently selected from an organic group and, where at least one selected from R′, R″, A and B comprises an epoxy group, at least one selected from R′, R″, A and B comprises an aliphatic hydroxy group, and at least one selected from R′, R″, A and B comprises an aromatic chromophore. Preferably the epoxy group is a terminal epoxy group. The organic group can be exemplified by the hydrocarbyl group and the hydrocarbylene group as have been described previously.

More specific examples of the organic group, A, B, R′ and R″, are an aromatic group, an alkyl group, a heterocyclic epoxy group, alkylene epoxy group, alkylene aromatic group, alkylene group, substituted alkylene group, alkylene group substituted with an aromatic group, and substituted alkylene ester group. Further examples of A are unsubstituted or substituted aliphatic alkylene, unsubstituted or substituted aromatic, unsubstituted or substituted cycloaliphatic, unsubstituted or substituted heterocyclic groups and combinations thereof. Additional examples include unsubstituted or substituted phenyl, unsubstituted or substituted naphthyl, unsubstituted or substituted benzophenone, methylene, ethylene, propylene, butylene, and 1-phenyl-1,2-ethylene. Further examples of B are unsubstituted or substituted linear or branched alkylene optionally containing one or more oxygen or sulfur atoms, unsubstituted or substituted arylene, and unsubstituted or substituted aralkylene. Additional examples of organic groups include methylene, ethylene, propylene, butylene, 1-phenyl-1,2-ethylene, 2-bromo-2-nitro-1,3-propylene, 2-bromo-2-methyl-1,3-propylene, —CH₂OCH₂—, —CH₂CH₂OCH₂CH₂—, —CH₂CH₂SCH₂CH₂—, or —CH₂CH₂SCH₂CH₂SCH₂CH—, phenylethylene, alkylnitroalkylene, bromonitroalkylene, phenyl and naphthyl. Further examples of R′ and R″ are independently aliphatic alcohol, primary aliphatic alcohol, secondary aliphatic alcohol, aliphatic etheralcohols, alkylaryl etheralcohols, heteroaliphatic alcohol, aliphatic glycidyl alcohol, glycidyl heteroaliphatic alcohol, aliphatic glycidylether alcohol, heteroaliphatic glycidylether and groups in FIGS. 1 and 2. Examples of hydrocarbyl and hydrocarbylene moieties containing the functional groups are shown in FIGS. 1 and 2 and may represent R′ and R″.

More specifically R′ and R″ can be derived from reacting the free acid in the polyester, where the polyester is made with a dianhydride and a polyol, with compounds such as ethylene glycol diglycidyl ether, butanediol diglycidyl ether, poly(ethylene glycol diglycidyl ether, poly(propylene glycol diglycidyl ether, trimethylolpropane triglycidyl ether, triphenylolmethane triglycidyl ether, triphenylolmethane triglycidyl ether 2,6-tolylene diisocyanate adduct, glycerol propoxylate triglycidyl ether, tris(2,3-epoxypropyl)isocyanurate, glycerol diglyidyl ether.

Examples of possible hydrocarbyl and hydrocarbylene units present in the various embodiments of the polymer of the present invention are given in FIGS. 1 and 2.

One example of the unit of structure 1 is structure 2,

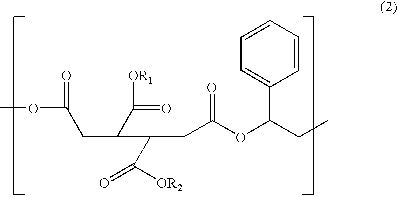

where R₁ and R₂ are R′ and R″ as defined previously.

Similarly, polyester resin comprising a chromophore and at least one hydroxy group, but free of epoxy groups can be made.

The underlayer composition comprises the polyester resin described and the thermal acid generator. Other compounds and/or polymers may be present, such as crosslinking agents and/or photoacid generator.

In the polymer of the present invention comprising the epoxy group in the various embodiments, the epoxy group can range from about 10 to about 80 mole percent, and preferably from about 30 to about 60 mole percent.

The condensation polymers or the free radical polymers may be made using standard techniques of polymerization. The weight average molecular weight may range from about 1,000 to about 1,000,000, and preferably 1500 to 60,000.

The novel composition comprises the polymer and an acid generator. The acid generator can be a thermal acid generator capable of generating a strong acid upon heating. The thermal acid generator (TAG) used in the present invention may be any one or more that upon heating generates an acid which can react with the polymer and propagate crosslinking of the polymer present in the invention, particularly preferred is a strong acid such as a sulfonic acid. Preferably, the thermal acid generator is activated at above 90° C. and more preferably at above 120° C., and even more preferably at above 150° C. Examples of thermal acid generators are metal-free sulfonium salts and iodonium salts, such as triarylsulfonium, dialkylarylsulfonium, and diarylalkylsulfonium salts of strong non-nucleophilic acids, alkylaryliodonium, diaryliodonium salts of strong non-nucleophilic acids; and ammonium, alkylammonium, dialkylammonium, trialkylammonium, tetraalkylammonium salts of strong non nucleophilic acids. Also, covalent thermal acid generators are also envisaged as useful additives for instance 2-nitrobenzyl esters of alkyl or arylsulfonic acids and other esters of sulfonic acid which thermally decompose to give free sulfonic acids. Examples are diaryliodonium perfluoroalkylsulfonates, diaryliodonium tris(fluoroalkylsulfonyl)methide, diaryliodonium bis(fluoroalkylsulfonyl)methide, diarlyliodonium bis(fluoroalkylsulfonyl)imide, diaryliodonium quaternary ammonium perfluoroalkylsulfonate. Examples of labile esters: 2-nitrobenzyl tosylate, 2,4-dinitrobenzyl tosylate, 2,6-dinitrobenzyl tosylate, 4-nitrobenzyl tosylate; benzenesulfonates such as 2-trifluoromethyl-6-nitrobenzyl 4-chlorobenzenesulfonate, 2-trifluoromethyl-6-nitrobenzyl 4-nitro benzenesulfonate; phenolic sulfonate esters such as phenyl, 4-methoxybenzenesulfonate; quaternary ammonium tris(fluoroalkylsulfonyl)methide, and quaternaryalkyl ammonium bis(fluoroalkylsulfonyl)imide, alkyl ammonium salts of organic acids, such as triethylammonium salt of 10-camphorsulfonic acid. A variety of aromatic (anthracene, naphthalene or benzene derivatives) sulfonic acid amine salts can be employed as the TAG, including those disclosed in U.S. Pat. Nos. 3,474,054, 4,200,729, 4,251,665 and 5,187,019. Preferably the TAG will have a very low volatility at temperatures between 170-220° C. Examples of TAGs are those sold by King Industries under Nacure and CDX names. Such TAG's are Nacure 5225, and CDX-2168E, which is a dodecylbenzene sulfonic acid amine salt supplied at 25-30% activity in propylene glycol methyl ether from King Industries, Norwalk, Conn. 06852, USA. The novel composition may further contain a photoacid generator, examples of which without limitation, are onium salts, sulfonate compounds, nitrobenzyl esters, triazines, etc. The preferred photoacid generators are onium salts and sulfonate esters of hydroxyimides, specifically diphenyl iodnium salts, triphenyl sulfonium salts, dialkyl iodonium salts, triakylsulfonium salts, and mixtures thereof.

The coating composition of the present invention may contain 1 weight % to about 15 weight % of the absorbing polymer, and preferably 4 weight % to about 10 weight %, of total solids. The acid generator, may be incorporated in a range from about 0.1 to about 10 weight % by total solids of the antireflective coating composition, preferably from 0.3 to 5 weight % by solids, and more preferably 0.5 to 2.5 weight % by solids. The secondary polymer, oligomer or compound, when used, may range from about 1 weight % to about 10 weight %, of total solids. Other components may be added to enhance the performance of the coating, e.g. monomeric dyes, lower alcohols, surface leveling agents, adhesion promoters, antifoaming agents, etc. Other polymers, such as, novolaks, polyhydroxystyrene, polymethylmethacrylate and polyarylates, may be added to the composition, providing the performance is not negatively impacted. Preferably the amount of this polymer is kept below 50 weight % of the total solids of the composition, more preferably 20 weight %, and even more preferably below 10 weight %.

The novel coating composition can comprise a polymer, a crosslinking agent, an acid generator, and a solvent composition.

A variety of crosslinking agents can be used in the composition of the present invention. Any suitable crosslinking agents that can crosslink the polymer in the presence of an acid may be used. Examples, without limitation, of such crosslinking agents are resins containing melamines, methylols, glycoluril, polymeric glycolurils, benzoguanamine, urea, hydroxy alkyl amides, epoxy and epoxy amine resins, blocked isocyanates, and divinyl monomers. Monomeric melamines like hexamethoxymethyl melamine; glycolurils like tetrakis(methoxymethyl)glycoluril; and aromatic methylols, like 2,6 bishydroxymethyl p-cresol may be used. Crosslinking agents disclosed in US 2006/0058468 and incorporated herein by reference, where the crosslinking agent is a polymeric glycoluril obtained by reacting at least one glycoluril compound with at least one reactive compound containing at least one hydroxy group and/or at least one acid group may be used.

The solid components of the antireflection coating composition are mixed with a solvent or mixtures of solvents that dissolve the solid components of the antireflective coating. Suitable solvents for the antireflective coating composition may include, for example, a glycol ether derivative such as ethyl cellosolve, methyl cellosolve, propylene glycol monomethyl ether, diethylene glycol monomethyl ether, diethylene glycol monoethyl ether, dipropylene glycol dimethyl ether, propylene glycol n-propyl ether, or diethylene glycol dimethyl ether, a glycol ether ester derivative such as ethyl cellosolve acetate, methyl cellosolve acetate, or propylene glycol monomethyl ether acetate; carboxylates such as ethyl acetate, n-butyl acetate and amyl acetate; carboxylates of di-basic acids such as diethyloxalate and diethylmalonate; dicarboxylates of glycols such as ethylene glycol diacetate and propylene glycol diacetate; and hydroxy carboxylates such as methyl lactate, ethyl lactate, ethyl glycolate, and ethyl-3-hydroxy propionate; a ketone ester such as methyl pyruvate or ethyl pyruvate; an alkoxycarboxylic acid ester such as methyl 3-methoxypropionate, ethyl 3-ethoxypropionate, ethyl 2-hydroxy-2-methylpropionate, or methylethoxypropionate; a ketone derivative such as methyl ethyl ketone, acetyl acetone, cyclopentanone, cyclohexanone or 2-heptanone; a ketone ether derivative such as diacetone alcohol methyl ether; a ketone alcohol derivative such as acetol or diacetone alcohol; lactones such as butyrolactone; an amide derivative such as dimethylacetamide or dimethylformamide, anisole, and mixtures thereof.

Since the novel film is coated on top of the substrate and is also subjected to dry etching, it is envisioned that the film is of sufficiently low metal ion level and of sufficient purity that the properties of the semiconductor device are not adversely affected. Treatments such as passing a solution of the polymer through an ion exchange column, filtration, and extraction processes can be used to reduce the concentration of metal ions and to reduce particles.

The absorption parameter (k) of the novel composition ranges from about 0.05 to about 1.0, preferably from about 0.1 to about 0.8 at the exposure wavelength, as derived from ellipsometric measurements. In one embodiment the composition has a k value in the range of about 0.2 to about 0.5 at the exposure wavelength. The refractive index (n) of the antireflective coating is also optimized and can range from about 1.3 to about 2.0, preferably 1.5 to about 1.8. The n and k values can be calculated using an ellipsometer, such as the J. A. Woollam WVASE VU-32™ Ellipsometer. The exact values of the optimum ranges for k and n are dependent on the exposure wavelength used and the type of application. Typically for 193 nm the preferred range for k is about 0.05 to about 0.75, and for 248 nm the preferred range for k is about 0.15 to about 0.8.

The novel coating composition is coated on the substrate using techniques well known to those skilled in the art, such as dipping, spin coating or spraying. The film thickness of the antireflective coating can range from about 15 nm to about 200 nm. The coating is further heated on a hot plate or convection oven for a sufficient length of time to remove any residual solvent and induce crosslinking, and thus insolubilizing the antireflective coating to prevent intermixing between the antireflective coatings. The preferred range of temperature is from about 90° C. to about 250° C. If the temperature is below 90° C. then insufficient loss of solvent or insufficient amount of crosslinking takes place, and at temperatures above 300° C. the composition may become chemically unstable. Other types of antireflective coatings may be coated above the present coating. Multiple antireflective coatings with differing n and k values can be used. A film of photoresist is then coated on top of the uppermost antireflective coating and baked to substantially remove the photoresist solvent. An edge bead remover may be applied after the coating steps to clean the edges of the substrate using processes well known in the art.

The substrates over which the antireflective coatings are formed can be any of those typically used in the semiconductor industry. Suitable substrates include, without limitation, silicon, silicon substrate coated with a metal surface, copper coated silicon wafer, copper, aluminum, polymeric resins, silicon dioxide, metals, doped silicon dioxide, silicon nitride, tantalum, polysilicon, ceramics, aluminum/copper mixtures; gallium arsenide and other such Group III/V compounds. The substrate may comprise any number of layers made from the materials described above.

Photoresists can be any of the types used in the semiconductor industry, provided the photoactive compound in the photoresist and the antireflective coating absorb at the exposure wavelength used for the imaging process.

To date, there are several major deep ultraviolet (uv) exposure technologies that have provided significant advancement in miniaturization, and these radiation of 248 nm, 193 nm, 157 and 13.5 nm. Photoresists for 248 nm have typically been based on substituted polyhydroxystyrene and its copolymers/onium salts, such as those described in U.S. Pat. No. 4,491,628 and U.S. Pat. No. 5,350,660. On the other hand, photoresists for exposure below 200 nm require non-aromatic polymers since aromatics are opaque at this wavelength. U.S. Pat. No. 5,843,624 and U.S. Pat. No. 6,866,984 disclose photoresists useful for 193 nm exposure. Generally, polymers containing alicyclic hydrocarbons are used for photoresists for exposure below 200 nm. Alicyclic hydrocarbons are incorporated into the polymer for many reasons, primarily since they have relatively high carbon to hydrogen ratios which improve etch resistance, they also provide transparency at low wavelengths and they have relatively high glass transition temperatures. U.S. Pat. No. 5,843,624 discloses polymers for photoresist that are obtained by free radical polymerization of maleic anhydride and unsaturated cyclic monomers. Any of the known types of 193 nm photoresists may be used, such as those described in U.S. Pat. No. 6,447,980 and U.S. Pat. No. 6,723,488, and incorporated herein by reference.

Two basic classes of photoresists sensitive at 157 nm, and based on fluorinated polymers with pendant fluoroalcohol groups, are known to be substantially transparent at that wavelength. One class of 157 nm fluoroalcohol photoresists is derived from polymers containing groups such as fluorinated-norbornenes, and are homopolymerized or copolymerized with other transparent monomers such as tetrafluoroethylene (U.S. Pat. No. 6,790,587, and U.S. Pat. No. 6,849,377) using either metal catalyzed or radical polymerization. Generally, these materials give higher absorbencies but have good plasma etch resistance due to their high alicyclic content. More recently, a class of 157 nm fluoroalcohol polymers was described in which the polymer backbone is derived from the cyclopolymerization of an asymmetrical diene such as 1,1,2,3,3-pentafluoro-4-trifluoromethyl-4-hydroxy-1,6-heptadiene (Shun-ichi Kodama et al Advances in Resist Technology and Processing XIX, Proceedings of SPIE Vol. 4690 p76 2002; U.S. Pat. No. 6,818,258) or copolymerization of a fluorodiene with an olefin (U.S. Pat. No. 6,916,590). These materials give acceptable absorbance at 157 nm, but due to their lower alicylic content as compared to the fluoro-norbornene polymer, have lower plasma etch resistance. These two classes of polymers can often be blended to provide a balance between the high etch resistance of the first polymer type and the high transparency at 157 nm of the second polymer type. Photoresists that absorb extreme ultraviolet radiation (EUV) of 13.5 nm are also useful and are known in the art.

After the coating process, the photoresist is imagewise exposed. The exposure may be done using typical exposure equipment. The exposed photoresist is then developed in an aqueous developer to remove the treated photoresist. The developer is preferably an aqueous alkaline solution comprising, for example, tetramethyl ammonium hydroxide. The developer may further comprise surfactant(s). An optional heating step can be incorporated into the process prior to development and after exposure.

The process of coating and imaging photoresists is well known to those skilled in the art and is optimized for the specific type of resist used. The patterned substrate can then be dry etched with an etching gas or mixture of gases, in a suitable etch chamber to remove the exposed portions of the antireflective film, with the remaining photoresist acting as an etch mask. Various etching gases are known in the art for etching organic antireflective coatings, such as those comprising CF₄, CF₄/O₂, CF₄, CHF₃, or Cl₂/O₂.

Each of the documents referred to above are incorporated herein by reference in its entirety, for all purposes. The following specific examples will provide detailed illustrations of the methods of producing and utilizing compositions of the present invention. These examples are not intended, however, to limit or restrict the scope of the invention in any way and should not be construed as providing conditions, parameters or values which must be utilized exclusively in order to practice the present invention.

### EXAMPLES

The refractive index (n) and the absorption (k) values of the antireflective coating in the Examples below were measured on a J. A. Woollam VASE32 ellipsometer.

The molecular weight of the polymers was measured on a Gel Permeation Chromatograph.

### EXAMPLES

### Synthesis Example 1

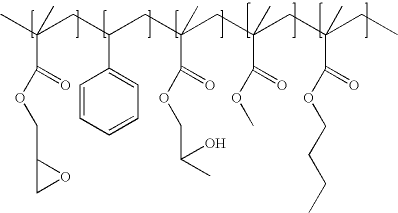

7.29 g (0.07 mol) of Styrene, 7.11 g (0.05 mol) of glycidyl methacrylate, 6.51 g (0.05 mol) of 2-hydroxypropylmethacrylate, 16.35 g (0.1633 mol) of methyl methacrylate, and 149 g of propyleneglycol monomethyletheracetate (PGMEA) were charged into a 500 ml flask fitted with a condenser, a thermal controller and a mechanical stirrer under nitrogen purge, 0.99 g of azobisisobutyronitrile (AIBN) was added and the mixture was heated to 90° C. and maintained for 18 hrs. Then, the reaction was raised to 100° C. for 1 hour. The reaction was cooled to room temperature and the polymer was slowly precipitated into water, collected and dried. 40 g of polymer was obtained with a weight average molecular weight (MW) of about 18,000 g/mol determined by GPC (polystyrene as standard).

### Filling Example 1

A via filling composition was prepared by dissolving 5 g of the polymer prepared in Synthesis Example 1 and 0.05 g of triethylammonium salt of nonafluorobutane-1-sulfonic acid in 50 g propyleneglycol monomethyletheracetate (PGMEA). The solution was filtered through 0.2 μm filter. The filling performance of the formulation was evaluated with a substrate with vias patterned in it. The via sizes ranged from 130 nm to 300 nm in diameter, 650 nm in depth, and pitch (distance between vias) ranged from 1:1 to isolated vias. The solution was spin coated onto the substrate and baked at 200° C. to 225° C. for 90 seconds. No voids in the filling of the material were observed with cross-section scanning electron microscope (SEM).

### Lithographic Evaluation Example 1

The lithographic performance of the anti-reflective coating formulation was evaluated using AZ® EXP T83742 photoresist. An antireflective coating solution was obtained by diluting 20 g of composition in via filling example 1 with 30 g of PGMEA. The above solution was spun onto an 8″ silicon wafer at 2500 rpm and the wafer was then baked at 200° C. for 90 seconds to give a film thickness of 75 nm. Then the wafer was used to measure refractive indices, n and k, on a J.A. Woollam VUV-Vase Ellipsometer, ModelVU-302. Refractive indices of the film were found to be as following, n (193 nm)=1.7, k (193 nm)=0.3. The solution was then coated on a silicon wafer and baked at 200° C. for 90 seconds. Using AZ® EXP T83742 photoresist (available from AZ Electronic Material USA Corp., 70 Meister Ave., Somerville, N.J.) a 190 nm film was coated over the antireflective coating and baked at 115° C. for 60 seconds. The wafer was then imagewise exposed using a 193 nm exposure tool. The exposed wafer was baked at 110° C. for 60 seconds and developed using a 2.38 wt % aqueous solution of tetramethyl ammonium hydroxide for 60 seconds. The line and space patterns when observed under scanning electron microscope (SEM) showed no standing waves, thus indicating the efficacy of the bottom anti-reflective coating.

### Synthesis Example 2

13.5 (0.076 mol) of Benzyl methacrylate, 12.3 (0.087 mol) of Glycidyl methacrylate, 6.3 g (0.043 mol) of 2-Hydroxypropylmethacrylate, 0.71 g (0.005 mol) of butyl methacrylate, 36.5 g (4.06 mol) of methyl methacrylate, and 180 g of propyleneglycol monomethyletheracetate (PGMEA) were charged into a 500 ml flask fitted with a condenser, a thermal controller and a mechanical stirrer under nitrogen purge. 0.99 g of azobisisobutyronitrile (AIBN) was added and the mixture was heated to 90° C. and maintained for 18 hrs. Then, the reaction was raised to 100° C. for 1 hour. The reaction was cooled to room temperature and the polymer was slowly precipitated into water, collected and dried. 40 g of polymer was obtained with a weight average molecular weight (MW) of about 18,000 g/mol determined by GPC (polystyrene as standard).

### Via Filling Example 2

A via filling composition was prepared by dissolving 5 g of the polymer prepared in Synthesis Example 2 and 0.05 g of triethylammonium salt of nonafluorobutane-1-sulfonic acid in 50 g propyleneglycol monomethyletheracetate (PGMEA). The solution was filtered through 0.2 μm filter. The filling performance of the formulation was evaluated with a substrate with vias patterned in it. The via sizes ranged from 130 nm to 300 nm in diameter, 650 nm in depth, and pitch ranged from 1:1 to isolated vias. The solution was spin coated onto the substrate and baked at 200° C. to 225° C. for 90 seconds. Good filling with no voids were observed with cross-section SEM.

### Lithographic Evaluation Example 2

The lithographic performance of the anti-reflective coating formulation was evaluated using AZ® EXP T83742 photoresist. An antireflective solution was obtained by diluting 20 g of composition in via filling example 2 with 30 g of PGMEA. The solution was then coated on a silicon wafer and baked at 200° C. for 90 seconds. The antireflective film was found to have (n) value of 1.84 and (k) value of 0.29. The solution was then coated on a silicon wafer and baked at 200° C. for 90 seconds. Using AZ® EXP T83742 photoresist a 190 nm film was coated and baked at 115° C. for 60 seconds. The wafer was then imagewise exposed using a 193 nm exposure tool. The exposed wafer was baked at 110° C. for 60 seconds and developed using a 2.38 wt % aqueous solution of tetramethyl ammonium hydroxide for 60 seconds. The line and space patterns when observed under scanning electron microscope showed no standing waves, thus indicating the efficacy of the bottom anti-reflective coating.

### Synthesis Example 3

348.9 g (1.98 mol) of Benzyl methacrylate, 96.0 g (0.675 mol) of Glycidyl methacrylate, 49.7 g (0.345 mol) of 2-Hydroxypropylmethacrylate and 1978 g of propyleneglycol monomethyletheracetate (PGMEA) were charged into a 5000 ml flask fitted with a condenser, a thermal controller and a mechanical stirrer under nitrogen purge. 9.36 g of azobisisobutyronitrile (AIBN) was added and the mixture was heated to 90° C. and maintained for 18 hrs. Then, the reaction was raised to 100° C. for 1 hour. The reaction was cooled to room temperature and the polymer was slowly precipitated into water, collected and dried. 490 g of polymer was obtained with a weight average molecular weight (MW) of about 18,000 g/mol determined by GPC (polystyrene as standard).

### Lithographic Evaluation Example 3

An underlayer BARC composition was prepared by dissolving 1 g of the polymer prepared in Synthesis Example 3 and 0.01 g of triethylammonium salt of nonafluorobutane-1-sulfonic acid in 50 g propyleneglycol monomethyletheracetate (PGMEA). The solution was filtered through 0.2 μm filter. A two layer bottom anti-reflective coating stack was prepared onto a silicon wafer by spin coating this underlayer BARC at 2500 RPM and baking at 200° C. for 60 seconds to give a film thickness of 35 nm followed by spin-coating an upper layer BARC (AZ® EXP ArF EB-68B, (available from AZ® Electronic Material USA Corp., 70 Meister Ave., Somerville, N.J.) and baking at 200° C. for 60 seconds. The lithographic performance of the anti-reflective coating stack was evaluated using AZ® EXP T83742 photoresist. A 190 nm resist film was coated and baked at 115° C. for 60 seconds. The wafer was then imagewise exposed using a 193 nm exposure tool. The exposed wafer was baked at 110° C. for 60 seconds and developed using a 2.3.8 wt % aqueous solution of tetramethyl ammonium hydroxide for 60 seconds. The line and space patterns when observed under scanning electron microscope showed no standing waves, thus indicating the efficacy of the bottom anti-reflective coating.

### Synthesis Example 4

8.23 (0.079 mol) of Styrene, 15.2 g (0.12 mol) of 2-Hydroxypropylmethacrylate, 13.8 g (0.014 mol) of methyl methacrylate, and 149 g of propyleneglycol monomethyletheracetate (PGMEA) were charged into a 500 ml flask fitted with a condenser, a thermal controller and a mechanical stirrer under nitrogen purge. 0.99 g of azobisisobutyronitrile (AIBN) was added and the mixture was heated to 90° C. and maintained for 18 hrs. Then, the reaction was raised to 100° C. for 1 hour. The reaction was cooled to room temperature and the polymer was slowly precipitated into water, collected and dried. 45 g of polymer was obtained with a weight average molecular weight (MW) of about 18,000 g/mol determined by GPC (polystyrene as standard).

### Via Filling Example 4

An antireflective filling composition was prepared by dissolving 5 g of the polymer prepared in Synthesis Example 4, 1.5 g of EPON™ Resin 1031 (available from Hexion Specialty Chemicals, Inc. Columbus, Ohio), 0.05 g of triethylammonium salt of nonafluorobutane-1-sulfonic acid, 0.006 g of FC-4430 FLUORAD™ Fluorosurfactant (available from 3M, St. Paul, Minn.), and 70 g propyleneglycol monomethyletheracetate (PGMEA). The solution was filtered through 0.2 μm filter. The filling performance of the formulation was evaluated with a substrate with vias patterned in it. The via sizes ranged from 130 nm to 300 nm in diameter, 650 nm in depth, and pitch ranged from 1:1 to isolated vias. The solution was spin coated onto the substrate and baked at 200° C. to 225° C. for 90 seconds. Good filling and no voids were observed with cross-section SEM.

### Synthesis Example 5

36.7 g (0.21 mol) of Benzyl methacrylate, 11.8 g (0.083 mol) of Glycidyl methacrylate, 6.0 g (0.042 mol) of 2-Hydroxypropylmethacrylate, and 218 g of propyleneglycol monomethyletheracetate (PGMEA) were charged into a 500 ml flask fitted with a condenser, a thermal controller and a mechanical stirrer under nitrogen purge. 1.04 g of azobisisobutyronitrile (AIBN) was added and the mixture was heated to 90° C. and maintained for 18 hrs. Then, the reaction was raised to 100° C. for 1 hour. The reaction was cooled to room temperature and the polymer was slowly precipitated into water, collected and dried. 40 g of polymer was obtained with a weight average molecular weight (MW) of about 18,000 g/mol determined by GPC (polystyrene as standard).

### Synthesis Example 6

12.34 (0.07 mol) of Benzyl methacrylate, 7.11 g (0.05 mol) of Glycidyl methacrylate, 6.51 g (0.05 mol) of 2-hydroxyethyl methacrylate, 16.35 g (0.16 mol) of methyl methacrylate, and 169 g of propyleneglycol monomethyletheracetate (PGMEA) were charged into a 500 ml flask fitted with a condenser, a thermal controller and a mechanical stirrer under nitrogen purge. 0.99 g of azobisisobutyronitrile (AIBN) was added and the mixture was heated to 90° C. and maintained for 18 hrs. Then, the reaction was raised to 100° C. for 1 hour. The reaction was cooled to room temperature and the polymer was slowly precipitated into water, collected and dried. 40 g of polymer was obtained with a weight average molecular weight (MW) of about 20,000 g/mol determined by GPC (polystyrene as standard).

### Lithographic Evaluation Example 6

The lithographic performance of the anti-reflective coating formulation was evaluated using AZ® EXP T83742 photoresist. An antireflective solution was prepared by dissolving 4 g of the polymer prepared in Synthesis Example 6 and 0.04 g of triethylammonium salt of nonafluorobutane-1-sulfonic acid in 100 g propyleneglycol monomethyletheracetate (PGMEA). The solution was then coated on a silicon wafer and baked at 200° C. for 90 seconds. The antireflective film was found to have (n) value of 1.83 and (k) value of 0.31. The solution was then coated on a silicon wafer and baked at 200° C. for 90 seconds. Using AZ® EXP T83742 photoresist a 190 nm film was coated and baked at 115° C. for 60 seconds. The wafer was then imagewise exposed using a 193 nm exposure tool. The exposed wafer was baked at 110° C. for 60 seconds and developed using a 2.38 wt % aqueous solution of tetramethyl ammonium hydroxide for 60 seconds. The line and space patterns when observed under scanning electron microscope showed no standing waves, thus indicating the efficacy of the bottom anti-reflective coating.

### Synthesis Example 7

40 g (0.2 mol) of butanetetracarboxylic acid dianhydride, 28 g (0.2 mol) of styrene glycol and 4 g of benzyltributylammonium chloride were added in 140 g of PGMEA. The temperature was raised to 110° C. until a homogeneous solution was obtained. The mixture was maintained at 110° C. for 4 h and cooled down to room temperature. 445 g (4.8 mol) of epichlorohydrin was added in the above mixture and the reaction was allowed to mix at 56° C. for 36 h. After cooling down, the product was precipitated in ether and air dried. The polymer was re-dissolved in acetone and re-precipitated in water. The solid product was dried and collected. The weight average molecular Weight (MW) was about 15,000 g/mol as determined by GPC (polystyrene as standard).

### Via Filling Example 7

A filling composition was prepared by dissolving 5 g of the polymer prepared in Synthesis Example 7, 0.05 g of triethylammonium salt of nonafluorobutane-1-sulfonic acid, 0.004 g of FC-4430 FLUORAD™ Fluorosurfactant (available from 3M, St. Paul, Minn.), and 50 g propyleneglycol monomethyletheracetate (PGMEA). The solution was filtered through 0.2 μm filter. The filling performance of the formulation was evaluated with a substrate with vias patterned in it. The via sizes ranged from 130 nm to 300 nm in diameter, 650 nm in depth, and pitch ranged from 1:1 to isolated vias. The solution was spin coated onto the substrate and baked at 200° C. to 225° C. for 90 seconds. Good filling and no voids were observed with cross-section SEM.

### Synthesis Example 8

10 g of butanetetracarboxylic acid dianhydride, 7 g of styrene glycol, 0.5 g of benzyltributylammonium chloride, and 35 g of propyleneglycol monomethyletheracetate (PGMEA) were charged into a flask with a condenser, thermal controller and a mechanical stirrer. Under nitrogen and stirring, the mixture was heated to 110° C. A clear solution was obtained after ˜1-2 hr. The temperature was kept at 110° C. for 3 hrs. Upon cooling, 30 g of PGMEA, 30 g of acetonitrile, 36 g of propylene oxide and 21 g of tris(2,3-epoxypropyl) isocyanurate were mixed with the above solution. The reaction was kept at 55° C. for 24 hrs. The reaction solution was cooled to room temperature and slowly poured into a large amount of water in a high speed blender. The polymer was collected and washed thoroughly with water. Finally the polymer was dried in a vacuum oven. 22 g of polymer was obtained with a weight average molecular weight (MW) of about 15,000 g/mol.

### Synthesis Example 9

10 g of butanetetracarboxylic acid dianhydride, 7 g of styrene glycol, 0.5 g of benzyltributylammonium chloride, and 35 g of propyleneglycol monomethyletheracetate (PGMEA) were charged into a flask with a condenser, thermal controller and a mechanical stirrer. Under nitrogen and stirring, the mixture was heated to 110° C. A clear solution was obtained after ˜1-2 hr. The temperature was kept at 110° C. for 3 hrs. Upon cooling, 25 g of propylene oxide and 30 g of 1,4-butanediol diglycidyl ether were mixed with the above solution. The reaction was kept at 55° C. for 40 hrs. The reaction solution was cooled to room temperature and slowly poured into large amount of Water in a high speed blender. The polymer was collected and washed thoroughly with water. Finally the polymer was dried in a vacuum oven. 20 g of polymer was obtained with a weight average molecular weight (MW) of about 40,000 g/mol.

### Synthesis Example 10

40 g of 1, 2, 4, 5-benzenetetracarboxylic dianhydride, 14 g of ethylene glycol, and 90 g of acetonitrile were charged into a flask with a condenser, thermal controller and a mechanical stirrer. Under nitrogen and stirring, the mixture was heated to 90° C. The reaction mixture was refluxed at 85° C. for 24 h. After cooling down to 40° C. or lower, 80 g of acetonitrile, 123 g of propylene oxide, 54 g of tris(2,3-epoxypropyl)isocyanurate, and 1 g of benzyltributylammonium chloride, were added in the above solution. The reaction was kept at 55° C. for 24 hrs. The reaction solution was cooled to room temperature and slowly poured into large amount of water in a high speed blender. The polymer was collected and Washed thoroughly with water. Finally the polymer was dried in a vacuum oven. 130 g of polymer was obtained with a weight average molecular weight (MW) of about 19,000 g/mol.

### Synthesis Example 11

15.8 g of butanetetracarboxylic acid dianhydride, 2.8 g of 1,2,4,5-benzenetetracarboxylic dianhydride, 5.8 g of styrene glycol, 5.6 g of neopentyl glycol and 1.0 g of benzyltributylammonium chloride were charged with 70 g of PEMEA solvent into a flask with a condenser, thermal controller and a mechanical stirrer. Under nitrogen and stirring, the mixture was heated to 100° C. The reaction was allowed overnight for 16-18 h. After cooling down to 40° C. or lower, 50 g of PGMEA, 50 g of acetonitrile, 66 g of propylene oxide and 38 g of tris(2,3-epoxypropyl)isocyanurate were added in the above solution. The reaction was kept at 55° C. for 24 hrs. The reaction solution was cooled to room temperature and slowly poured into large amount of water in a high speed blender. The polymer was collected and washed thoroughly with water. Finally the polymer was dried in a vacuum oven. 36 g of polymer was obtained with a weight average molecular weight (MW) of about 51,000 g/mol.

### Synthesis Example 12

10 g of butanetetracarboxylic acid dianhydride, 3.5 g of styrene glycol, 2.3 g of 2-methyl propanediol, 0.5 g of benzyltributylammonium chloride and 35 g of PGMEA solvent were charged into a flask with a condenser, thermal controller and a mechanical stirrer. Under nitrogen and stirring, the mixture was heated to 110° C. The reaction was allowed for 4 h at 110° C. After cooling down to 40° C. or lower, 30 g of PGMEA, 30 g of acetonitrile, 33 g of propylene oxide and 15 g of tris(2,3-epoxypropyl)isocyanurate were added in the above solution. The reaction was kept at 55° C. for 24 hrs. The reaction solution was cooled to room temperature and slowly poured into large amount of water in a high speed blender. The polymer was collected and washed thoroughly with water. Finally the polymer was dried in a vacuum oven.

### Litho Formulation Example 13

1.0 g of the Synthesis Example 8 was dissolved in 30 g of PGMEA/PGME 70/30 solvent to make a 3.3 wt % solution. 1% of nanofluorobutanesulfonic acid/triethylamine and 0.05% of triphenylsulfonium nonaflate (TPSNf) was added in the polymer solution. The mixture then was filtered through a micro filter with a pore size of 0.2 um.

### Litho Formulation Example 14

600 grams of tetramethoxymethyl glycoluril, 96 grams of styrene glycol and 1200 grams of PGMEA were charged into a 2 L jacketed flask with a thermometer, mechanical stirrer and a cold water condenser and heated to 85° C. After a catalytic amount of para-toluenesulfonic acid monohydrate was added, the reaction was maintained at this temperature for 5 hrs. The reaction solution was then cooled to room temperature and filtered. The filtrate was slowly poured into distilled water while stirring to precipitate the polymer. The polymer was filtered, washed thoroughly with water and dried in a vacuum oven (250 grams were obtained). The polymer obtained had a weight average molecular weight of about 17,345 g/mol and a polydispersity of 2.7.

0.67 g of the polymer solid from Synthesis Example 8 and 0.33 g of the polymer from this example was dissolved in 30 g of PGMEA/PGME 70/30 solvent to make a 3.3 wt % solution. 1% of nanofluorobutanesulfonic acid/triethylamine and 1% of TPSNf was added in the polymer solution. The mixture then Was filtered through a micro filter with a pore size of 0.2 um.

### Filling Formulation Example 15

3.0 g of the polymer solid from Synthesis Example 8 was dissolved in 30 g of PGMEA/PGME 700/30 solvent to make a 10 wt % solution. 0.5% of nanofluorobutanesulfonic acid/triethylamine was added in the polymer solution. The mixture then was filtered through a micro filter with a pore size of 0.2 um.

### Litho Performance Example 16

The performance of the anti-reflective coating formulation from Litho Formulation Example 13 and 14 were evaluated using T83472 photoresist (product of AZ Electronic Materials USA Corp., NJ, USA). About 82 nm thick film was coated and baked at 200° C. for 90 seconds on a silicon wafer with the anti-reflective coating formulation of this Example. Then a 190 nm thick T83472 photoresist solution was coated and baked at 115° C. for 60 seconds. The wafer was then imagewise exposed using a Nikon NSR-306D 193 nm scanner with 0.85NA, under dipole Y illumination of 0.9 sigma with PSM mask. The exposed wafer was baked at 110° C. for 60 seconds and developed in AZ®300MIF developer (available from AZ Electronic Materials USA Corp., NJ, USA) for 30 seconds. The cleaned wafer was then examined under scanning electron microscope. Results: The line and space patterns showed no standing waves, no footing and no scumming, thus indicating the efficacy of the bottom anti-reflective coating.

### Via Filling Test Example 17

The filling performance of the anti-reflective coating formulation from Filling Formulation Example 15 was evaluated on silicon wafers. About 300 nm thick film of the Formulation Example 1 was coated and baked at 200° C. for 90 seconds on a silicon wafer with the anti-reflective coating formulation of this Example. The same coating spin speed was used to spin coat the silicon wafers with patterned vias at SB conditions of 200° C./90 s, 225° C./90 s, 250° C./90 s, and 250° C./90 s+300° C./120 s. The coated wafers were then examined under scanning electron microscope. The results showed no voids in the vias and on the surface. The iso/dense bias was less than 90 nm, which is considered good.

1. An underlayer coating composition capable of being crosslinked comprising a polymer, a compound capable of generating a strong acid, and optionally a crosslinking agent, further where the polymer comprises at least one absorbing chromophore and at least one moiety selected from an epoxy group, an aliphatic hydroxy group and mixtures thereof.

2. The underlayer coating composition of claim 1, where the polymer comprises at least one absorbing chromophore, at least one epoxy group and at least one aliphatic hydroxy group.

3. The underlayer coating composition of claim 1, where the polymer is free of silicon groups.

4. The underlayer coating composition of claim 1, where the crosslinking agent is selected from melamines, methylols, glycolurils, polymeric glycolurils hydroxy alkyl amides, epoxy and epoxy amine resins, blocked isocyanates, and divinyl monomers.

5. The underlayer coating composition of claim 1, where the polymer has an ethylenic backbone.

6. The underlayer coating composition of claim 1, further comprising a compound with a weight average molecular weight of less than 1,000, selected from a compound comprising two or more hydroxy groups, a compound comprising two or more epoxy groups, and a compound comprising at least one hydroxy group and at least one epoxy group.

7. The underlayer coating composition of claim 1, where the polymer comprises an absorbing chromophore and an epoxy group or hydroxy group.

8. The underlayer coating composition of claim 1, where the polymer comprises at least one unit derived from monomers selected from styrene, benzyl methacrylate, glycidyl methacrylate, hydroxypropyl methacrylate, and methyl(meth)acrylate.

9. The underlayer coating composition of claim 1, where the polymer is a polyester.

10. The underlayer coating composition of claim 1, where the polymer is a polyester free of carboxylic acid.

11. The underlayer coating composition of claim 1, where the polymer comprises a unit of structure, 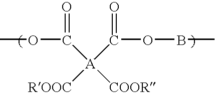
where, A, B, R′ and R″ are independently selected from an organic group, where at least one selected from R′, R″, A and B comprises an epoxy group, and at least one selected from R′, R″, A and B comprises an aromatic chromophore.

12. The underlayer coating composition of claim 11, Where A, B, R′ and R″ are independently selected from an aromatic group, an alkyl group, a heterocyclic epoxy group, alkyl epoxy group, aromatic group, alkylene aromatic group, alkylene group, substituted alkylene group, and substituted alkylene ester group.

13. The underlayer coating composition of claim 11, where R′ and R″ are independently selected from aliphatic alcohol, primary aliphatic alcohol, secondary aliphatic alcohol, aliphatic etheralcohols, alkylaryl etheralcohols, heteroaliphatic alcohol, aliphatic glycidyl alcohol, glycidyl heteroaliphatic alcohol, aliphatic glycidylether alcohol, and heteroaliphatic glycidylether.

14. The underlayer coating composition of claim 1, where the polymer has the structure, 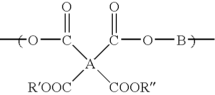
where, A, B, R′ and R″ are independently selected from an organic group, and, where at least one selected from R′, R″, A and B comprises an epoxy group, at least one selected from R′, R″, A and B comprises a hydroxy group, and at least one selected from R′, R″, A and B comprises an aromatic chromophore.

15. The underlayer coating composition of claim 14, where the hydroxy group is an alkylene hydroxy group.

16. The underlayer coating composition of claim 11, where the polymer is free of an acid group and/or phenolic group.

17. The underlayer coating composition of claim 1, where the compound capable of generating a strong acid is a thermal acid generator.

18. A process for manufacturing a microelectronic device, comprising;
a) providing a substrate with a first layer of an antireflective coating composition from claim 1;
b) optionally, providing at least a second antireflective coating layer over the first antireflective coating composition layer;
b) coating a photoresist layer above the antireflective coating layers;
c) imagewise exposing the photoresist layer;
d) developing the photoresist layer with an aqueous alkaline developing solution.

19. The process of claim 18, where the photoresist is sensitive from about 240 nm to about 30 nm.

20. The process according to claim 18, where the developing solution is an aqueous solution comprising a hydroxide base.
